(19) United States
(12) Patent Application Publication
(10) Pub. No.: US 2025/0321462 A1
(43) Pub. Date: Oct. 16, 2025

(54) DIRECTIVITY SWITCHING LIGHTING DEVICE

(71) Applicant: FUJIFILM Corporation, Tokyo (JP)

(72) Inventor: Yujiro YANAI, Kanagawa (JP)

(73) Assignee: FUJIFILM Corporation, Tokyo (JP)

(21) Appl. No.: 19/248,721

(22) Filed: Jun. 25, 2025

Related U.S. Application Data
(63) Continuation of application No. PCT/JP2024/001605, filed on Jan. 22, 2024.

(30) Foreign Application Priority Data
Jan. 23, 2023 (JP) 2023-008204

(51) Int. Cl. G02F 1/29; G02B 3/00; G02F 1/13; G02F 1/13363

(52) U.S. Cl. CPC G02F 1/294; G02B 3/0056; G02F 1/1323; G02F 1/133638; G02B 2207/123

(57) ABSTRACT

An object of the present invention is to provide a novel directivity switching lighting device that can switch the directivity of irradiated light. A light source; a polarization switching member that switches between right circularly polarized light and left circularly polarized light; a liquid crystal lens array; and a directivity control member that controls directivity of light emitted from the light source are provided, the light source, the polarization switching member, and the liquid crystal lens array are disposed in this order, and the directivity control member is disposed between the light source and the polarization switching member or between the polarization switching member and the liquid crystal lens array to achieve the object.

### CROSS-REFERENCE TO RELATED APPLICATIONS

This application is a Continuation of PCT International Application No. PCT/JP2024/001605 filed on Jan. 22, 2024, which claims priority under 35 U.S.C. § 119 (a) to Japanese Patent Application No. 2023-008204 filed on Jan. 23, 2023. The above applications are hereby expressly incorporated by reference, in their entirety, into the present application.

### BACKGROUND OF THE INVENTION

### 1. Field of the Invention

The present invention relates to a directivity switching lighting device that is used in a backlight unit or the like of a liquid crystal display device and is capable of switching the directivity of irradiation light.

### 2. Description of the Related Art

In electronic apparatuses for personal use such as a tablet personal computer (PC), a laptop PC, and a mobile phone such as a smartphone, there is a demand for preventing a screen from being peeped by a peripheral third party. Therefore, in these electronic apparatuses, the viewing angle of the screen is narrowed so that the screen is not to be peeped by a peripheral third party.

As a method of narrowing the viewing angle of a screen, a method of adhering a film (louver film) in which black stripes are formed or the like to a screen has been known.

However, in this method, the viewing angle of the screen is fixed at a narrow value. Therefore, for example, in a case where a screen needs to be visually recognized from an angle, such as a case where several people visually recognize the screen, the visibility in the oblique direction deteriorates, and the usability of the electronic apparatus deteriorates.

In order to solve such problems, in electronic apparatuses such as a tablet PC and a laptop PC, various image display devices that switch between an image display with a wide viewing angle and an image display with a narrow viewing angle to realize security such as prevention of a peep from the side and if necessary, sufficient visibility from the side have been proposed.

Here, a liquid crystal display device is used as an image display device for a tablet PC and a laptop PC. In the liquid crystal display device, it has been proposed that switching is performed between an image display with a wide viewing angle and an image display with a narrow viewing angle by switching the directivity of the backlight light emitted from a backlight unit between a wide range and a narrow range.

For example, JP2007-57855A describes an image display module including a transmissive image display panel in which pixels are arranged, a light source having minute light source units disposed to correspond to the arrangement of the pixels on a one-to-one basis or a one-to-X basis, and a lens group that refracts light rays entering the pixels or light rays emitted from the pixels and guides the light rays to a predetermined part to be observed.

In addition, JP2007-57855A also describes a configuration in which, in the image display module, each lens of the lens group, consisting of a liquid lens that deforms by energization, guides the light rays entering the pixels or the light rays emitted from the pixels to a predetermined part to be observed in a first shape state, and guides the light rays entering the pixels or the light rays emitted from the pixels to an unspecified region in a second shape state.

According to the image display module described in JP2007-57855A, it is possible to display an image in a predetermined part to be observed (narrow viewing angle) without using a louver or the like for viewing angle control, and it is possible to switch between an image display in the predetermined part to be observed and an image display in an unspecified region (wide viewing angle).

### SUMMARY OF THE INVENTION

As described in JP2007-57855A, for example, in order to switch between an image display with a wide viewing angle and an image display with a narrow viewing angle in a liquid crystal display device, lighting devices of various configurations that switch the directivity of emitted light are known.

An object of the present invention is to provide a novel illumination device that is different from any of the devices, can be used as a backlight unit or the like of a liquid crystal display device, and can switch the directivity of irradiated light.

In order to achieve the object, the present invention has the following configurations.

[1] A directivity switching lighting device comprising:
a light source;
a polarization switching member that switches between right circularly polarized light and left circularly polarized light;
a liquid crystal lens array; and
a directivity control member that controls directivity of light emitted from the light source,
in which the light source, the polarization switching member, and the liquid crystal lens array are disposed in this order, and
the directivity control member is disposed between the light source and the polarization switching member or between the polarization switching member and the liquid crystal lens array.

[2] The directivity switching lighting device according to [1], in which the polarization switching member has a polarizing plate, a liquid crystal cell, and a λ/4 plate in this order from a light source side.

[3] The directivity switching lighting device according to [1] or [2], in which the directivity control member has one or more of a louver member, a prism sheet, or a collimating lens array.

[4] The directivity switching lighting device according to [3], in which the louver member is an arrangement of light-shielding cylindrical bodies that are provided corresponding to liquid crystal lenses forming the liquid crystal lens array.

[5] The directivity switching lighting device according to any one of [1] to [4], in which the liquid crystal lens forming the liquid crystal lens array is a liquid crystal diffraction lens that includes a liquid crystal layer having a concentric liquid crystal alignment pattern in which an orientation of an optical axis derived from a liquid crystal compound changes while continuously rotating along at least one in-plane direction, in which a liquid crystal compound is immobilized.

According to the present invention, provided is a novel directivity switching lighting device that can be used as a backlight unit or the like of a liquid crystal display device, and can switch the directivity of irradiated light.

### BRIEF DESCRIPTION OF THE DRAWINGS

FIG. 1 is a diagram conceptually showing an example of a directivity switching lighting device according to an embodiment of the present invention.

FIG. 2 is a perspective view conceptually showing a liquid crystal lens array and a directivity control member.

FIG. 3 is a plan view conceptually showing an example of a liquid crystal lens.

FIG. 4 is a cross-sectional view conceptually showing an example of the liquid crystal lens.

FIG. 5 is a conceptual view for describing the liquid crystal lens.

FIG. 6 is a conceptual view for describing an action of the liquid crystal lens.

FIG. 7 is a conceptual view for describing an action of the liquid crystal lens.

FIG. 8 is a diagram conceptually showing an exposure device for creating a liquid crystal lens.

### DESCRIPTION OF THE PREFERRED EMBODIMENTS

Hereinafter, a directivity switching lighting device according to an embodiment of the present invention will be described in detail based on suitable examples shown in the accompanying drawings.

The following description of configuration requirements is based on representative embodiments of the present invention, but the present invention is not limited to the embodiments.

In addition, all the drawings shown below are conceptual views for describing the present invention. The shape, size, thickness, positional relationship, and the like of each member do not necessarily match with the actual ones.

In the present specification, a numerical range expressed using “to” means a range including numerical values before and after “to” as a lower limit value and an upper limit value.

The directivity switching lighting device according to the embodiment of the present invention is a planar lighting device that can switch the directivity of irradiation light (emitted light) between light irradiation to a wide range in a diffusive manner and light irradiation to a narrow range.

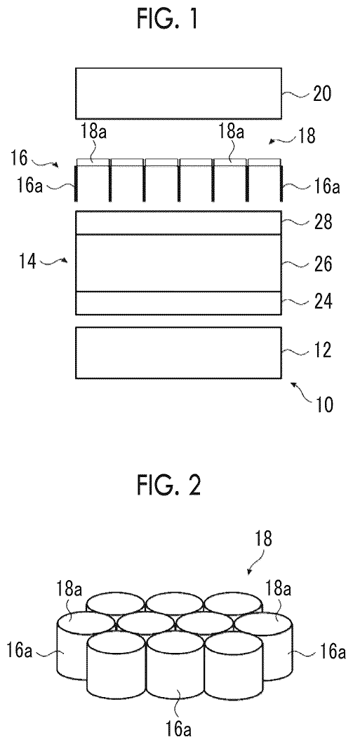

FIG. 1 conceptually shows an example of the directivity switching lighting device according to the embodiment of the present invention.

A directivity switching lighting device 10 shown in FIG. 1 has a light source unit 12, a polarization switching member 14, a directivity control member 16, and a liquid crystal lens array 18.

In the following description, the “directivity switching lighting device” will also be simply referred to as a “lighting device”.

In the lighting device 10, the liquid crystal lens array 18 is provided by two-dimensionally arranging a plurality of liquid crystal lenses 18a (liquid crystal diffraction lenses 18a) in a planar shape. In addition, the polarization switching member 14 switches the polarized light of light entering the liquid crystal lens array 18, that is, the liquid crystal lens 18a, to right circularly polarized light or left circularly polarized light.

In the lighting device 10, the light emitted from the light source unit 12 is switched to right circularly polarized light or left circularly polarized light by the polarization switching member 14, and enters the liquid crystal lens array 18. In the lighting device 10, in a case where the light entering the liquid crystal lens array 18 is one circularly polarized light, the liquid crystal lens 18a is allowed to act as a convex lens to irradiate light to a narrow range, and in a case where the light entering the liquid crystal lens array 18 is the other circularly polarized light, the liquid crystal lens 18a is allowed to act as a concave lens to irradiate light to a wide range.

FIG. 1 shows a state in which the lighting device 10 according to the embodiment of the present invention is used as, for example, a backlight unit of a liquid crystal display device, and the lighting device 10 causes backlight light to enter a liquid crystal display unit 20. That is, in the example shown in FIG. 1, the liquid crystal display device is composed of the lighting device 10 according to the embodiment of the present invention and the liquid crystal display unit 20.

In the liquid crystal display device shown in FIG. 1, in a case where the irradiation range of the backlight light entering the liquid crystal display unit 20 from the lighting device 10 is switched between a wide range and a narrow range, the viewing angle characteristics of image display in the liquid crystal display device can be switched between a wide viewing angle and a narrow viewing angle.

The liquid crystal display unit 20 is a known liquid crystal display unit (liquid crystal display panel) in which a backlight unit is removed from a liquid crystal display device having a liquid crystal cell, a transparent electrode, a backlight-side polarizing plate, an emission-side polarizing plate, and the like.

In the lighting device 10, the light source unit 12 is a light source unit that emits so-called planar light.

As the light source unit 12, various known planar light source units that are used for a backlight unit or the like of a liquid crystal display device can be used.

Accordingly, the light source unit 12 may be a so-called direct planar light source unit in which a plurality of light sources (light emitting elements) are disposed on a substrate. Otherwise, the light source unit 12 may be a so-called edge light type (side light type) planar light source unit in which light from a light source is allowed to enter an end part of a light guide plate to irradiate planar light from a main surface of the light guide plate.

In addition, the light source unit 12 (lighting device 10) may irradiate white light, irradiate monochromatic light such as red light, green light, and blue light, or irradiate light of a mixed color obtained by appropriately combining two of red light, green light, and blue light.

In a case where the light source unit 12 irradiates white light, the white light may be emitted using a red light source, a green light source, and a blue light source. Otherwise, in a case where the light source unit 12 irradiates white light, a wavelength conversion member such as a quantum dot that converts blue light into red light and green light may be used to irradiate the white light using blue light emitted from the light source and red light and green light obtained by conversion with the wavelength conversion member.

In addition, if necessary, the light source unit 12 may have a known light diffusion unit for making the brightness of planar light to be irradiated uniform over the whole surface, such as a light diffusion plate and two prism sheets disposed orthogonally to each other, which is provided in a backlight unit or the like of a liquid crystal display device.

The light emitted from the light source unit 12 enters the polarization switching member 14.

The polarization switching member 14 switches the unpolarized light emitted from the light source unit 12 to right circularly polarized light or left circularly polarized light.

In the example shown in the drawing, the polarization switching member 14 has a linearly polarizing plate 24, a liquid crystal cell 26, and a λ/4 plate 28 in this order from the light source unit 12 side.

First, the light emitted from the light source unit 12 enters the linearly polarizing plate 24 of the polarization switching member 14.

The linearly polarizing plate 24 is a known linearly polarizing plate (linear polarizer) that transmits the unpolarized light emitted from the light source unit 12 by converting it into linearly polarized light.

Accordingly, the linearly polarizing plate 24 may be a reflection type polarizing plate or an absorption type polarizing plate. That is, as the linearly polarizing plate 24, various known linearly polarizing plates such as an iodine-based polarizing plate, a dye-based polarizing plate using a dichroic dye, a polyene-based polarizing plate, a wire grid polarizing plate, and a film provided by stretching a dielectric multi-layer film described in JP2011-053705A can be used.

Then, the linearly polarized light transmitted through the linearly polarizing plate 24 enters the liquid crystal cell 26.

The liquid crystal cell 26 is a known liquid crystal cell that does not have a pixel structure and can switch a phase difference between 0 and λ/2 (½ wavelength) by applying a driving voltage. Accordingly, a driving power source (not shown) is connected to the liquid crystal cell 26.

As the liquid crystal cell 26, various known liquid crystal cells such as a twisted nematic (TN) liquid crystal cell, a vertical alignment (VA) liquid crystal cell, and an in-plane switching (IPS) liquid crystal cell can be used.

The liquid crystal cell 26 transmits the linearly polarized light transmitted through the linearly polarizing plate 24 (phase difference 0) as it is, or converts the polarization direction by 90° (phase difference λ/2) to provide linearly polarized light orthogonal to the entering linearly polarized light.

In the following description, for convenience, the linearly polarized light transmitted through the linearly polarizing plate 24 will also be referred to as horizontally polarized light, and the linearly polarized light in a direction orthogonal to the horizontally polarized light will also be referred to as vertically polarized light. That is, the liquid crystal cell 26 emits the horizontally polarized light transmitted through the linearly polarizing plate 24 as it is, or emits the horizontally polarized light by converting it into vertically polarized light.

The λ/4 plate 28 is also a known λ/4 plate (¼ wavelength plate, ¼ phase difference plate), and has, for example, a phase difference of 100 to 180 nm at a wavelength of 550 nm.

Accordingly, as the λ/4 plate 28, various known λ/4 plates such as a stretched polycarbonate film, a stretched norbornene-based polymer film, a transparent film in which inorganic particles having birefringence such as strontium carbonate are included and aligned, a thin film with an inorganic dielectric obliquely deposited on a support, a film in which a polymerizable liquid crystal compound is uniaxially aligned and the alignment is immobilized, and a film in which a liquid crystal compound is uniaxially aligned and the alignment is immobilized can be used.

The λ/4 plate 28 converts the horizontally polarized light transmitted through the liquid crystal cell 26 into right circularly polarized light, and converts the vertically polarized light into left circularly polarized light. Otherwise, the λ/4 plate 28 converts the horizontally polarized light transmitted through the liquid crystal cell 26 into left circularly polarized light, and converts the vertically polarized light into right circularly polarized light.

Accordingly, the direction of a slow axis of the λ/4 plate 28 is set so that the horizontally polarized light and the vertically polarized light emitted from the liquid crystal cell 26 are converted into right circularly polarized light or left circularly polarized light.

That is, a combination of the liquid crystal cell 26 and the λ/4 plate 28 acts as a wavelength plate that can switch the phase difference between −λ/4 and λ/4.

In the lighting device according to the embodiment of the present invention, the polarization switching member is not limited to a member having the linearly polarizing plate 24, the liquid crystal cell 26 that can switch the phase difference between 0 and λ/2, and the λ/4 plate 28.

That is, in the lighting device according to the embodiment of the present invention, various optical elements can be used as the polarization switching member as long as they can switch the unpolarized light emitted from the light source unit 12 to right circularly polarized light or left circularly polarized light.

Examples of the polarization switching member include one having a combination of the same linearly polarizing plate and a liquid crystal cell that does not have a pixel structure and can switch a phase difference between −λ/4 and λ/4 by applying a driving voltage. In this polarization switching member, the horizontally polarized light transmitted through the linearly polarizing plate is converted into right circularly polarized light or left circularly polarized light by the liquid crystal cell having a retardation of −λ/4 or λ/4, and is emitted.

As the liquid crystal, an IPS liquid crystal cell is used, and examples thereof include a configuration in which an axis of the IPS liquid crystal cell and an axis of the linearly polarizing plate are disposed at 45° or 135°. The axis of the IPS liquid crystal cell is a slow axis or a fast axis. In addition, the axis of the linearly polarizing plate is a transmission axis or an absorption axis.

In this case, it is necessary to reduce And of the liquid crystal cell, and the thickness of the IPS liquid crystal cell is reduced to half of the thickness of a liquid crystal cell in the related art. An represents the birefringence of a liquid crystal compound forming the liquid crystal cell, and d represents the thickness of the liquid crystal cell. The thickness of a liquid crystal cell in the related art is the thickness of a liquid crystal layer itself, and is, for example, the thickness of a liquid crystal layer between a transparent electrode and glass with an alignment film attached thereto.

The circularly polarized light transmitted through the polarization switching member 14 (λ/4 plate 28) then enters the directivity control member 16, and then enters the liquid crystal lens array 18.

The directivity control member 16 is a member that controls a traveling direction of light to make the circularly polarized light entering the liquid crystal lens 18a of the liquid crystal lens array 18 as parallel to an optical axis of the liquid crystal lens 18a as possible. In other words, the directivity control member 16 is a member that controls the directivity of light so that the circularly polarized light enters the liquid crystal lens 18a in a straight line with as little angle as possible relative to the optical axis.

As described above, in the liquid crystal lens array 18, the plurality of liquid crystal lenses 18a are two-dimensionally arranged in a plane. In the example shown in the drawing, the liquid crystal lens 18a has a circular shape. Here, the shape of the liquid crystal lens is a planar shape. In addition, the planar shape of the liquid crystal lens is a shape in a direction orthogonal to the optical axis.

In response to this, the directivity control member 16 in the example shown in the drawing is a louver member in which cylindrical members 16a that are light-shielding (black) cylinders having a center line that matches the optical axis of the liquid crystal lens 18a are arranged corresponding to the individual liquid crystal lenses 18a as conceptually shown in FIG. 2. Accordingly, among the circularly polarized light (light) rays entering the directivity control member 16, that is, the cylindrical members 16a, circularly polarized light rays forming a large angle with respect to the optical axis of the liquid crystal lens 18a are shielded (absorbed) by the cylindrical members 16a.

In the lighting device 10, in a case where the directivity control member 16 is provided, it is possible to allow only light whose traveling direction is parallel or nearly parallel to the optical axis of the liquid crystal lens 18a to enter the liquid crystal lens 18a.

In a case where the directivity control member 16 is provided, the light travelling in directions in an unnecessary wide range can be reduced in narrowing the irradiation range of the light irradiated from the lighting device 10.

As a result, for example, in a case where the lighting device 10 according to the embodiment of the present invention is used as a backlight unit of a liquid crystal display device that can switch the viewing angle characteristics between a wide viewing angle and a narrow viewing angle, it is possible to suitably prevent an image from an unnecessary direction from being visually recognized (observed) in an image display with a narrow viewing angle.

In the lighting device according to the embodiment of the present invention, the directivity control member 16 is not limited to the louver member as shown in the example shown in the drawing. That is, as the directivity control member, various optical members that control (regulate) a traveling direction of light to make the circularly polarized light entering the liquid crystal lens 18a of the liquid crystal lens array 18 parallel or nearly parallel to the optical axis of the liquid crystal lens 18a can be used.

For example, a prism sheet (prism film) such as a brightness enhancement film (BEF) manufactured by 3M Company, a collimating lens array in which collimating lenses are two-dimensionally arranged, or the like can also be suitably used as the directivity control member in the lighting device according to the embodiment of the present invention.

A plurality of the directivity control members may be used in combination.

In the lighting device 10 in the example shown in the drawing, the directivity control member 16 is disposed between the polarization switching member 14 and the liquid crystal lens array 18, but the present invention is not limited thereto. In the lighting device according to the embodiment of the present invention, the directivity control member 16 may be disposed between the light source unit 12 and the polarization switching member 14.

Here, in a case where the above-described prism sheet and collimating lens array are used as the directivity control member, the directivity control member is preferably disposed between the light source unit 12 and the polarization switching member 14 to suppress the disturbance of circularly polarized light.

In addition, in a case where the louver member (light-shielding member) is used as the directivity control member as in the example shown in the drawing, the directivity control member is preferably disposed between the polarization switching member 14 and the liquid crystal lens array 18 in consideration of the effect of directivity control.

The circularly polarized light whose directivity, that is, traveling direction has been controlled by the directivity control member 16 then enters the liquid crystal lens array 18.

As described above, the liquid crystal lens 18a is circular in the example shown in the drawing. In addition, in the liquid crystal lens array 18, the plurality of liquid crystal lenses 18a are two-dimensionally arranged in a plane, and in the example shown in the drawing, the liquid crystal lenses 18a are arranged in a close-packed manner.

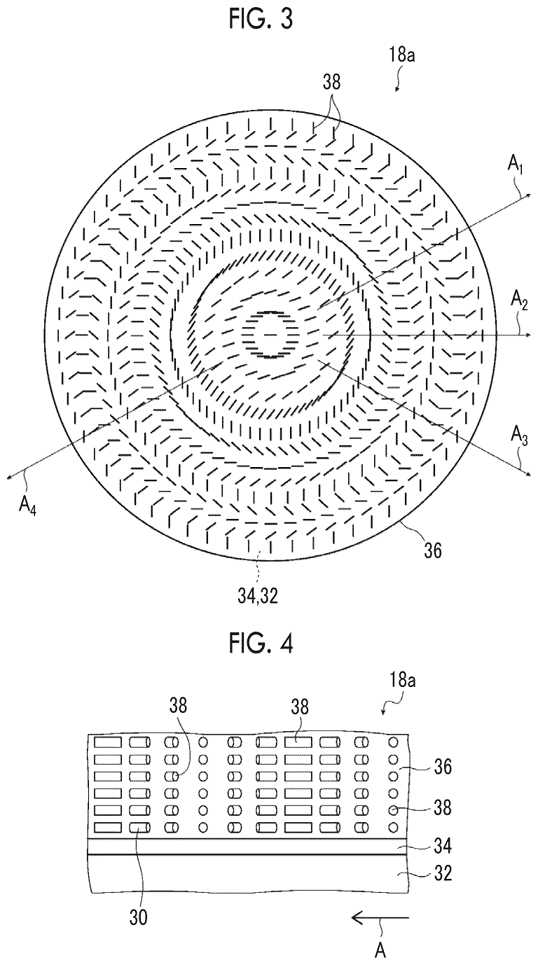

FIGS. 3 and 4 conceptually show an example of the liquid crystal lens 18a. FIG. 3 is a plan view of the liquid crystal lens 18a, and FIG. 4 is a cross-sectional view of the liquid crystal lens 18a in a thickness direction.

As shown in FIGS. 3 and 4, the liquid crystal lens 18a has a substrate 32, an alignment film 34, and a liquid crystal layer 36. In the liquid crystal lens 18a, the liquid crystal layer 36 acts as a liquid crystal lens (liquid crystal diffractive lens).

Accordingly, the liquid crystal lens 18a may be composed only of the liquid crystal layer 36, may be formed by peeling off the substrate 32 and then including the alignment film 34 and the liquid crystal layer 36, or may be formed by peeling off the substrate 32 and the alignment film 34 from the liquid crystal layer 36 and laminating the liquid crystal layer 36 on another substrate.

In the liquid crystal lens 18a shown in FIGS. 3 and 4, the liquid crystal layer 36 is a liquid crystal layer formed of a composition including a liquid crystal compound 38 on the alignment film 34, in which the liquid crystal compound 38 is aligned and immobilized in the following liquid crystal alignment pattern.

Specifically, the liquid crystal layer 36 has a liquid crystal alignment pattern in a radial shape from an inner side toward an outer side, the liquid crystal alignment pattern being a pattern in which the orientation of the optical axis derived from the liquid crystal compound 38 changes while continuously rotating in one direction. That is, the liquid crystal alignment pattern in the liquid crystal layer 36 shown in FIGS. 3 and 4 is a concentric pattern including the one direction in which the orientation of the optical axis derived from the liquid crystal compound 38 changes while continuously rotating in a concentric shape from the inner side toward the outer side.

In FIGS. 3 and 4, for example, a rod-like liquid crystal compound is used as the liquid crystal compound 38. Therefore, the direction of the optical axis matches a longitudinal direction of the liquid crystal compound 38.

More specifically, in the liquid crystal layer 36, the orientation of the optical axis of the liquid crystal compound 38 changes while continuously rotating along a plurality of directions from the center, that is, the optical axis of the liquid crystal layer 36 toward the outer side, for example, a direction indicated by an arrow A₁, a direction indicated by an arrow A₂, a direction indicated by an arrow A₃, a direction indicated by an arrow A₄, or . . . .

Accordingly, in the liquid crystal layer 36, the rotation direction of the optical axis of the liquid crystal compound 38 is the same in all directions (one direction). In the example shown in the drawing, the rotation direction of the optical axis of the liquid crystal compound 38 is counterclockwise, in all the directions including the direction indicated by the arrow A₁, the direction indicated by the arrow A₂, the direction indicated by the arrow A₃, and the direction indicated by the arrow A₄.

That is, in a case where the arrow A₁ and the arrow A₄ are regarded as one straight line, the rotation direction of the optical axis of the liquid crystal compound 38 is reversed at the center of the liquid crystal layer 36 on the straight line. For example, the straight line formed by the arrow A₁ and the arrow A₄ is directed in the right direction (arrow A₁ direction) in the drawing. In this case, the optical axis of the liquid crystal compound 38 initially rotates clockwise from the outer side toward the center of the liquid crystal layer 36, the rotation direction is reversed at the center of the liquid crystal layer 36, and then the optical axis of the liquid crystal compound 38 rotates counterclockwise from the center to the outer side of the liquid crystal layer 36. The center of the liquid crystal layer 36 is the optical axis of the liquid crystal lens.

As is well known, the liquid crystal layer (optically anisotropic layer) having a liquid crystal alignment pattern in which the orientation of the optical axis derived from the liquid crystal compound 38 changes while continuously rotating in one direction acts as a transmissive liquid crystal diffraction element that diffracts entering circularly polarized light in one direction along which the optical axis rotates and the reverse direction, depending on the rotation direction of the optical axis and the turning direction of the entering circularly polarized light.

Specifically, in the liquid crystal layer 36 having a liquid crystal alignment pattern in which the orientation of the optical axis of the liquid crystal compound 38 changes while continuously rotating in one direction, a diffraction direction (refraction direction) of transmitted light depends on the rotation directions of the optical axis of the liquid crystal compound 38. That is, in this liquid crystal alignment pattern, in a case where the rotation direction of the optical axis of the liquid crystal compound 38 is reversed, the diffraction direction of transmitted light is also reversed with respect to the one direction along which the optical axis rotates.

In addition, in the liquid crystal layer 36 having a liquid crystal alignment pattern in which the orientation of the optical axis of the liquid crystal compound 38 changes while continuously rotating in one direction, the diffraction direction of transmitted light varies depending on the turning direction of entering circularly polarized light. That is, in the liquid crystal alignment pattern, the diffraction direction of transmitted light is reversed between a case where the entering light is right circularly polarized light and a case where the entering light is left circularly polarized light.

Furthermore, in a case where an in-plane retardation (retardation in the plane direction) value is set to λ/2, the liquid crystal layer 36 has a function of a general λ/2 plate, that is, a function of imparting a phase difference of a half wavelength, that is, 180° to the polarized light components entering the liquid crystal layer.

Accordingly, the circularly polarized light that has entered the liquid crystal layer 36 and has then been diffracted has a reversed turning direction. That is, the right circularly polarized light that has entered the liquid crystal layer 36 and has then been diffracted is emitted as left circularly polarized light, and the left circularly polarized light is emitted as right circularly polarized light.

In the liquid crystal layer 36 of the liquid crystal lens 18a, in the liquid crystal alignment pattern, in a case where a length over which the orientation of the optical axis derived from the liquid crystal compound rotates by 180° in one direction along which the orientation of the optical axis derived from the liquid crystal compound 38 changes while continuously rotating is set as a single period, the length of the single period gradually decreases from the inner side toward the outer side.

Here, in the liquid crystal layer having a liquid crystal alignment pattern in which the orientation of the optical axis of the liquid crystal compound 38 changes while continuously rotating in one direction, the shorter the length of the single period, the larger the diffraction angle. Accordingly, in the liquid crystal layer 36 (liquid crystal lens 18a) having a concentric liquid crystal alignment pattern, the diffraction angle gradually increases from the center of the concentric circle toward the outside.

Accordingly, in the liquid crystal layer 36 having a concentric liquid crystal alignment pattern, in which the liquid crystal alignment pattern in which the optical axis derived from the liquid crystal compound changes while continuously rotating is radial, incident light (light beams) can be diverged or be focused and transmitted depending on the rotation direction of the optical axis of the liquid crystal compound 38 and the turning direction of entering circularly polarized light.

In other words, the liquid crystal lens 18a having the liquid crystal layer 36 acts, for example, as a concave lens in a case where right circularly polarized light enters, and acts as a convex lens in a case where left circularly polarized light enters, depending on the turning direction of entering circularly polarized light. Otherwise, the liquid crystal lens 18a acts as a convex lens in a case where right circularly polarized light enters, and acts as a concave lens in a case where left circularly polarized light enters.

Accordingly, in the lighting device 10 according to the embodiment of the present invention, as described above, the polarization switching member 14 switches the circularly polarized light entering the liquid crystal lens 18a to right circularly polarized light or left circularly polarized light, and thus the light can be diffused (diverged) by the liquid crystal lens 18a acting as a concave lens in a case where right circularly polarized light enters, so that the light can be irradiated to a wide region, and the light can be collected by the liquid crystal lens 18a acting as a convex lens in a case where left circularly polarized light enters, so that the light can be irradiated to a narrow region.

Otherwise, in the lighting device 10 according to the embodiment of the present invention, as described above, the polarization switching member 14 switches the circularly polarized light entering the liquid crystal lens 18a to right circularly polarized light or left circularly polarized light, and thus the light can be collected by the liquid crystal lens 18a acting as a convex lens in a case where right circularly polarized light enters, so that the light can be irradiated to a narrow region, and the light can be diffused by the liquid crystal lens 18a acting as a concave lens in a case where left circularly polarized light enters, so that the light can be irradiated to a wide region.

In FIG. 3, in order to simplify the drawing and to clarify the configuration of the liquid crystal lens 18a, only the liquid crystal compound 38 (liquid crystal compound molecules) on the surface of the alignment film 34 is shown in the liquid crystal layer 36. However, as conceptually shown in FIG. 4, the liquid crystal layer 36 has a structure in which the aligned liquid crystal compounds 38 are laminated as in a liquid crystal layer that is formed of a composition including a normal liquid crystal compound.

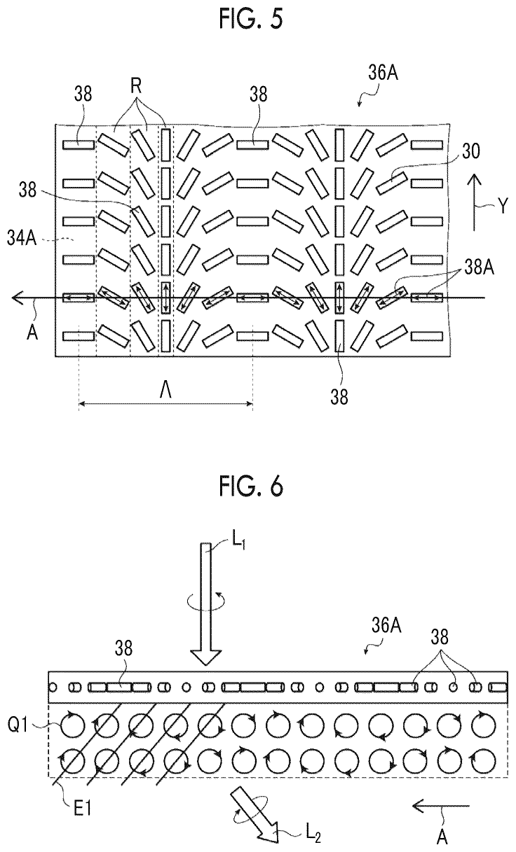

Hereinafter, an action of the liquid crystal layer 36 will be described in detail with reference to a liquid crystal layer 36A having a liquid crystal alignment pattern in which an optical axis 38A derived from the liquid crystal compound 38 changes while continuously rotating in one direction indicated by an arrow A as conceptually shown in a plan view of FIG. 5.

In the concentric liquid crystal alignment pattern shown in FIG. 3 including the one direction in which the optical axis changes while continuously rotating in a radial shape from the inner side toward the outer side, the same optical effects as those of the liquid crystal alignment pattern shown in FIG. 5 are also exhibited for the one direction in which the optical axis changes while continuously rotating.

In the following description, the optical axis 38A derived from the liquid crystal compound 38 will also be referred to as the “optical axis 38A of the liquid crystal compound 38” or the “optical axis 38A”.

In the liquid crystal layer 36A, the liquid crystal compound 38 is two-dimensionally aligned in a plane parallel to the one direction indicated by the arrow A and a Y direction orthogonal to the arrow A direction. In FIGS. 3 and 4 described below, the Y direction is a direction orthogonal to the paper plane.

In the following description, the “one direction indicated by the arrow A” will also be simply referred to as the “arrow A direction”.

In the liquid crystal layer 36 shown in FIG. 3, a circumferential direction of the concentric circle in the concentric liquid crystal alignment pattern corresponds to the Y direction in FIG. 5.

The liquid crystal layer 36A has a liquid crystal alignment pattern in which the orientation of the optical axis 38A derived from the liquid crystal compound 38 changes while continuously rotating along the arrow A direction in the plane of the liquid crystal layer 36A.

Specifically, the phrase “the orientation of the optical axis 38A of the liquid crystal compound 38 changes while continuously rotating in the arrow A direction (predetermined one direction)” represents that an angle between the optical axis 38A of the liquid crystal compound 38 arranged along the arrow A direction and the arrow A direction varies depending on positions in the arrow A direction, and the angle between the optical axis 38A and the arrow A direction sequentially changes from θ to θ+180° or θ−180° along the arrow A direction.

Meanwhile, regarding the liquid crystal compound 38 forming the liquid crystal layer 36A, liquid crystal compounds 38 in which the optical axis 38A is oriented in the same direction are arranged at regular intervals in the Y direction orthogonal to the arrow A direction, that is, the Y direction orthogonal to the one direction in which the optical axis 38A continuously rotates.

In other words, regarding the liquid crystal compound 38 forming the liquid crystal layer 36, in the liquid crystal compounds 38 arranged in the Y direction, angles between the direction of the optical axis 38A and the arrow A direction are the same.

In the liquid crystal layer 36 shown in FIG. 3, regions where the optical axis 38A is oriented in the same direction are formed in annular shapes with their centers matching each other, and a concentric liquid crystal alignment pattern is formed.

As described above, in the liquid crystal alignment pattern in which the optical axis 38A continuously rotates in one direction, a length (distance) over which the optical axis 38A of the liquid crystal compound 38 rotates by 180° is set as a length A of a single period in the liquid crystal alignment pattern.

That is, in the liquid crystal layer 36A shown in FIG. 5, a length (distance) over which the optical axis 38A of the liquid crystal compound 38 rotates by 180° in the arrow A direction in which the orientation of the optical axis 38A changes while continuously rotating in the plane is set as a single period A in the liquid crystal alignment pattern. In other words, the single period A in the liquid crystal alignment pattern is defined as a distance over which the angle between the optical axis 38A of the liquid crystal compound 38 and the arrow A direction changes from θ to θ+180°.

That is, a distance between centers of two liquid crystal compounds 38 in the arrow A direction is the single period A, the two liquid crystal compounds having the same angle with respect to the arrow A direction. Specifically, as shown in FIG. 5, a distance between centers in the arrow A direction of two liquid crystal compounds 38 in which the arrow A direction matches the direction of the optical axis 38A is the single period A.

In the liquid crystal alignment pattern in the liquid crystal layer 36A (liquid crystal layer 36), the single period A is repeated in the arrow A direction, that is, in one direction in which the orientation of the optical axis 38A changes while continuously rotating.

As described above, the liquid crystal layer 36A having such a liquid crystal alignment pattern is also a transmissive liquid crystal diffraction element, and the single period A is the period (single period) of the diffraction structure.

In the liquid crystal layer 36A, the liquid crystal compounds arranged in the Y direction have the same angle between the optical axis 38A and the arrow A direction. Regions where the liquid crystal compounds 38 in which the same angle is formed between the optical axis 38A and the arrow A direction are disposed in the Y direction will be referred to as regions R.

In this case, an in-plane retardation (Re) value of each region R is preferably a half wavelength, that is, λ/2. The in-plane retardation is calculated from the product of a difference Δn in refractive index generated by refractive index anisotropy of the region R and the thickness of the liquid crystal layer. Here, the difference in refractive index generated by refractive index anisotropy of the region R in the liquid crystal layer is defined by a difference between a refractive index in a direction of a slow axis in the plane of the region R and a refractive index in a direction orthogonal to the direction of the slow axis. That is, the difference Δn in refractive index generated by refractive index anisotropy of the region R is the same as a difference between a refractive index of the liquid crystal compound 38 in the direction of the optical axis 38A and a refractive index of the liquid crystal compound 38 in a direction perpendicular to the optical axis 38A in the plane of the region R. That is, the above-described difference Δn in refractive index is the same as the difference in refractive index of the liquid crystal compound.

In the liquid crystal lens 18a having a concentric liquid crystal alignment pattern, in which the liquid crystal alignment pattern in which the optical axis 38A continuously rotates in one direction is radial, regions where the optical axis 38A is oriented in the same direction, which are formed in annular shapes with their centers matching each other correspond to the regions R in FIG. 5.

In a case where circularly polarized light enters the liquid crystal layer 36A, the light is diffracted and the direction of the circularly polarized light is converted.

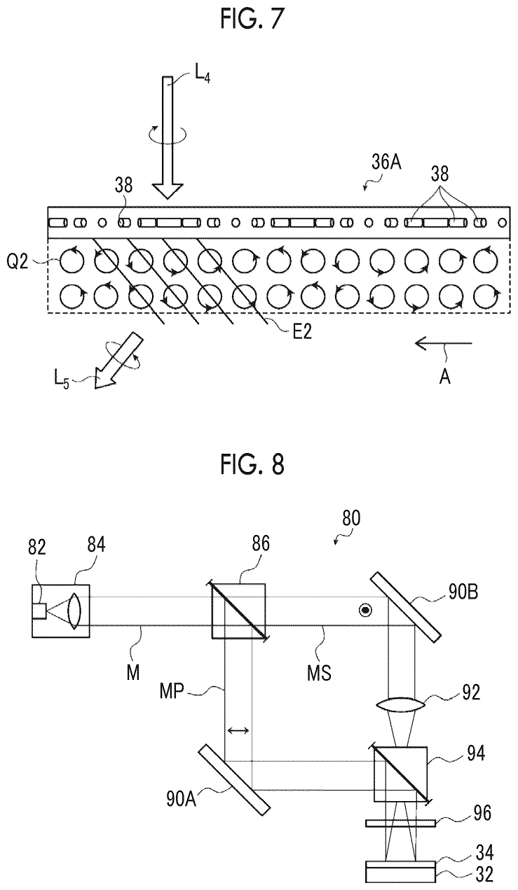

This action is conceptually shown in FIGS. 6 and 7. In the liquid crystal layer 36A, the value of the product of the difference in refractive index of the liquid crystal compound and the thickness of the liquid crystal layer is λ/2.

As described above, this action is also completely the same as that in the liquid crystal lens 18a having a concentric liquid crystal alignment pattern, in which the liquid crystal alignment pattern in which the optical axis 38A continuously rotates in one direction is radial.

As shown in FIG. 6, in a case where the value of the product of the difference in refractive index of the liquid crystal compound and the thickness of the liquid crystal layer is λ/2 in the liquid crystal layer 36A and incident light Ly as left circularly polarized light enters the liquid crystal layer 36A, the incident light L₁ is imparted with a phase difference of 180° by passing through the liquid crystal layer 36A, and transmitted light L₂ is converted into right circularly polarized light.

In addition, in a case where the incident light L₁ passes through the liquid crystal layer 36A, an absolute phase thereof changes depending on the orientation of the optical axis 38A of each liquid crystal compound 38. In this case, since the orientation of the optical axis 38A changes while rotating along the arrow A direction, the amount of change in the absolute phase of the incident light Ly varies depending on the orientation of the optical axis 38A. Furthermore, since the liquid crystal alignment pattern formed in the liquid crystal layer 36A is a pattern that is periodic in the arrow A direction, the incident light Ly passing through the liquid crystal layer 36A is imparted with an absolute phase Q1 that is periodic in the arrow A direction corresponding to the orientation of each optical axis 38A as shown in FIG. 6. Accordingly, an equiphase surface E1 that is inclined in a direction opposite to the arrow A direction is formed.

Therefore, the transmitted light L₂ is diffracted to be inclined in a direction perpendicular to the equiphase surface E1 and travels in a direction different from the traveling direction of the incident light L₁. This way, the incident light Ly as left circularly polarized light is converted into the transmitted light L₂ as right circularly polarized light that is inclined with respect to an incidence direction by a certain angle in the arrow A direction.

Meanwhile, as conceptually shown in FIG. 7, in a case where the value of the product of the difference in refractive index of the liquid crystal compound and the thickness of the liquid crystal layer is λ/2 in the liquid crystal layer 36A and incident light L₄ as right circularly polarized light enters the liquid crystal layer 36A, the incident light L₄ is imparted with a phase difference of 180° by passing through the liquid crystal layer 36A and converted into transmitted light L₅ as left circularly polarized light.

In addition, in a case where the incident light L₄ passes through the liquid crystal layer 36A, an absolute phase thereof changes depending on the orientation of the optical axis 38A of each liquid crystal compound 38. In this case, since the orientation of the optical axis 38A changes while rotating along the arrow A direction, the amount of change in the absolute phase of the incident light L₄ varies depending on the orientation of the optical axis 38A. Furthermore, since the liquid crystal alignment pattern formed in the liquid crystal layer 36A is a pattern that is periodic in the arrow A direction, the incident light L₄ passing through the liquid crystal layer 36A is imparted with an absolute phase Q2 that is periodic in the arrow A direction corresponding to the orientation of each optical axis 38A as shown in FIG. 7.

Here, since the incident light L₄ is right circularly polarized light, the absolute phase Q2 that is periodic in the arrow A direction corresponding to the orientation of the optical axis 38A is opposite to the incident light Ly as left circularly polarized light. As a result, in the incident light L₄, an equiphase surface E2 that is inclined in the arrow A direction opposite to that of the incident light L₁ is formed.

Therefore, the incident light L₄ is diffracted to be inclined in a direction perpendicular to the equiphase surface E2 and travels in a direction different from the traveling direction of the incident light L₄. This way, the incident light L₄ is converted into the transmitted light L₅ as left circularly polarized light that is inclined with respect to an incidence direction by a certain angle in a direction opposite to the arrow A direction.

In the liquid crystal layer 36A, by changing the single period A of the formed liquid crystal alignment pattern, the diffraction angles of the transmitted light L₂ and the transmitted light L₅ can be adjusted. Specifically, since the shorter the single period A of the liquid crystal alignment pattern, the stronger the interference between the light components passing through the liquid crystal compounds 38 adjacent to each other, the transmitted light L₂ and the transmitted light L₅ can be greatly diffracted.

In addition, in the liquid crystal layer 36A, by reversing the rotation direction of the optical axis 38A of the liquid crystal compound 38 that rotates along the arrow A direction, the diffraction direction of the transmitted light can be reversed.

Furthermore, in the liquid crystal layer 36A, the diffraction direction of the transmitted light is reversed depending on the turning direction of the entering circularly polarized light. That is, in the liquid crystal layer 36A, the transmitted light is diffracted in opposite directions for right circularly polarized light and left circularly polarized light.

Regarding the above points, the same also applies to the liquid crystal layer 36 (liquid crystal lens 18a) having a concentric liquid crystal alignment pattern as described above.

The liquid crystal layer 36 is formed of a liquid crystal composition including a rod-like liquid crystal compound or a disk-like liquid crystal compound, and has a liquid crystal alignment pattern in which an optical axis of the rod-like liquid crystal compound or an optical axis of the disk-like liquid crystal compound is aligned as described above.

In a case where the alignment film 34 having an alignment pattern corresponding to the above-described liquid crystal alignment pattern is formed on the substrate 32 and the liquid crystal composition is applied to the alignment film 34 and then cured, it is possible to form a liquid crystal layer 36 consisting of a cured layer of the liquid crystal composition.

The liquid crystal composition for forming the liquid crystal layer 36 contains a rod-like liquid crystal compound or a disk-like liquid crystal compound, and may further contain other components such as a leveling agent, an alignment control agent, a polymerization initiator, and an alignment assistant.

In addition, the liquid crystal layer 36 desirably has a wide bandwidth with respect to the wavelength of incident light, and is preferably formed of a liquid crystal material whose birefringence index exhibits reverse dispersion.

### —Rod-Like Liquid Crystal Compound—

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles can be preferably used. Not only the above low molecular weight liquid crystal molecules but also high molecular weight liquid crystal molecules can be used.

In the liquid crystal layer 36, it is more preferable to immobilize the alignment of the rod-like liquid crystal compound through polymerization. Compounds described in Makromol. Chem., (1989), Vol. 190, p. 2255, Advanced Materials (1993), Vol. 5, p. 107, U.S. Pat. No. 4,683,327A, 5,622,648A, 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), JP2001-64627, and the like can be used as polymerizable rod-like liquid crystal compounds. Furthermore, as the rod-like liquid crystal compound, for example, those described in JP1999-513019A (JP-H11-513019A) and JP2007-279688A can also be preferably used.

### —Disk-Like Liquid Crystal Compound—

As the disk-like liquid crystal compound, for example, those described in JP2007-108732A and JP2010-244038A can be preferably used.

In a case where the disk-like liquid crystal compound is used for the liquid crystal layer, the liquid crystal compound 38 rises in the thickness direction in the liquid crystal layer, and the optical axis 38A derived from the liquid crystal compound is defined as an axis perpendicular to a disc plane, that is, a so-called fast axis.

As described above, the liquid crystal lens 18a has the substrate 32, the alignment film 34, and the above-described liquid crystal layer 36.

As the substrate 32 forming the liquid crystal lens 18a, various sheet-like materials can be used as long as they can support the alignment film 34 and the liquid crystal layer 36 described below.

As the substrate 32, a transparent support is preferable, and examples thereof include a polyacrylic resin film such as polymethyl methacrylate, a cellulose-based resin film such as cellulose triacetate, a cycloolefin polymer-based film (for example, trade name “ARTON”, manufactured by JSR Corporation; or trade name “ZEONOR”, manufactured by Zeon Corporation), polyethylene terephthalate (PET), polycarbonate, and polyvinyl chloride. The support is not limited to a flexible film and may be a non-flexible substrate such as a glass substrate.

The alignment film 34 is formed on a surface of the substrate 32.

The liquid crystal alignment pattern in the liquid crystal layer 36 follows the alignment pattern formed on the alignment film 34. Accordingly, in the alignment film 34 for forming the liquid crystal layer having such a liquid crystal alignment pattern, the same alignment pattern as the liquid crystal alignment pattern in the liquid crystal layer 36 is formed.

The alignment film 34 having such an alignment pattern can be formed by, for example, forming a coating film including a compound having a photo-aligned group, drying the coating film, and exposing the coating film with an exposure device 80 described below.

Preferable examples of the compound having a photo-aligned group, that is, the photo-alignment material used for the photo-alignment film include: azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; aromatic ester compounds described in JP2002-229039A; maleimide- and/or alkenyl-substituted nadimide compounds having a photo-alignment unit described in JP2002-265541A and JP2002-317013A; photo-crosslinking silane derivatives described in JP4205195B and JP4205198B, photo-crosslinking polyimides, photo-crosslinking polyamides, and photo-crosslinking esters described in JP2003-520878A, JP2004-529220A, and JP4162850B; and photo-dimerizable compounds, in particular, cinnamate compounds, chalcone compounds, and coumarin compounds described in JP1997-118717A (JP-H9-118717A), JP1998-506420A (JP-H10-506420A), JP2003-505561A, WO2010/150748A, JP2013-177561A, and JP2014-12823A.

Among these, azo compounds, photo-crosslinking polyimides, photo-crosslinking polyamides, photo-crosslinking esters, cinnamate compounds, and chalcone compounds are suitably used.

FIG. 8 conceptually shows an example of an exposure device that exposes the coating film that becomes the alignment film 34 (photo-alignment film) for forming the liquid crystal layer 36 to form an alignment pattern corresponding to a concentric liquid crystal alignment pattern in which the optical axis changes while continuously rotating radially.

An exposure device 80 shown in FIG. 8 has: a light source 84 that includes a laser 82; a polarization beam splitter 86 that splits laser light M emitted from the laser 82 into S polarized light MS and P polarized light MP; a mirror 90A that is disposed on an optical path of the P polarized light MP; a mirror 90B that is disposed on an optical path of the S polarized light MS; a lens 92 that is disposed on the optical path of the S polarized light MS; a polarization beam splitter 94; and a λ/4 plate 96.

The P polarized light MP that is split by the polarization beam splitter 86 is reflected from the mirror 90A and enters the polarization beam splitter 94. Meanwhile, the S polarized light MS that is split by the polarization beam splitter 86 is reflected from the mirror 90B and collected by the lens 92 to enter the polarization beam splitter 94.

The P polarized light MP and the S polarized light MS are combined by the polarization beam splitter 94, are converted into right circularly polarized light and left circularly polarized light depending on the polarization direction by the λ/4 plate 96, and enter the alignment film 34 on the substrate 32.

Here, due to interference between the right circularly polarized light and the left circularly polarized light, the polarization state of the light with which the alignment film 34 is irradiated periodically changes like interference fringes. Since the intersecting angle between the right circularly polarized light and the left circularly polarized light changes from the inner side toward the outer side of the concentric circle, an exposure pattern in which the pitch changes from the inner side toward the outer side is obtained. Therefore, a radial (concentric) alignment pattern in which the alignment state periodically changes is obtained in the alignment film 34.

In the exposure device 80, a single period A in the liquid crystal alignment pattern in which the optical axis of the liquid crystal compound 30 continuously rotates by 180° along one direction can be controlled by changing the refractive power of the lens 92, the focal length of the lens 92, the distance between the lens 92 and the alignment film 34, and the like.

In addition, by adjusting the optical power of the lens 92 (F-number of the lens 92), a length of the single period in the liquid crystal alignment pattern can be changed in one direction in which the optical axis continuously rotates.

Specifically, the length of the single period in the liquid crystal alignment pattern can be changed in one direction in which the optical axis continuously rotates depending on a light spread angle at which light is spread by the lens 92 due to interference with parallel light. More specifically, in a case where the optical power of the lens 92 is decreased, light is approximated to parallel light, and thus the length A of the single period in the liquid crystal alignment pattern gradually decreases from the inner side toward the outer side. Conversely, in a case where the optical power of the lens 92 is increased, the length A of the single period in the liquid crystal alignment pattern rapidly decreases from the inner side toward the outer side.

That is, by adjusting the optical power of the lens 92, it is possible to adjust the optical power of the liquid crystal lens 18a (liquid crystal layer 36) that acts as a concave lens or a convex lens depending on the turning direction of entering circularly polarized light.

The liquid crystal lens array 18 may be the liquid crystal lens array 18 as shown in FIGS. 1 and 2 in which the liquid crystal lenses 18a individually produced are arranged one by one.

However, preferably, an alignment film 34 corresponding to the entire surface of the liquid crystal lens array 18 is used and repeatedly exposed by changing the position of the alignment film 34 so that the liquid crystal lenses 18a are arranged in a close-packed manner, for example. Thereafter, the liquid crystal composition is applied to the exposed alignment film 34 as described above to form the liquid crystal layer 36, whereby the liquid crystal lens array 18 can be provided as shown in FIGS. 1 and 2.

Accordingly, in this case, the liquid crystal lens array 18 has a single sheet shape.

In the lighting device 10 in the example shown in the drawing, the liquid crystal lenses 18a are disposed in a close-packed manner as conceptually shown in FIG. 2, but the present invention is not limited thereto.

For example, in the lighting device according to the embodiment of the present invention, the liquid crystal lenses 18a may be arranged in a lattice such as a square lattice or a houndstooth lattice. Alternatively, the liquid crystal lenses 18a may be arranged irregularly.

In consideration of unevenness in the brightness of irradiation light in the plane direction, the liquid crystal lenses 18a are preferably arranged with as few gaps as possible. In consideration of this point, as in the example shown in the drawing, the liquid crystal lenses 18a are preferably arranged in a close-packed manner in a case where the liquid crystal lenses 18a have a circular shape.

In addition, in the lighting device 10 in the example shown in the drawing, the shape (planar shape) of the liquid crystal lens 18a in the liquid crystal lens array 18 is a circular shape, but the present invention is not limited thereto.

For example, the shape of the liquid crystal lens may be a polygonal shape such as a square shape or a hexagonal shape, an elliptical shape, or the like. In addition, liquid crystal lenses having different shapes may be mixed in the liquid crystal lens array. In this case, in a case where the directivity control member is a louver member, the louver also has a tubular body corresponding to the shape of the liquid crystal lens.

However, in consideration of the concentric liquid crystal alignment pattern in the liquid crystal lens 18a (liquid crystal layer 36), the light collection function, and the light diffusion function, the shape of the liquid crystal lens 18a is preferably circular.

Hereinafter, the action of the lighting device 10 will be described.

In the example shown below, the liquid crystal lens 18a in the liquid crystal lens array 18 acts as a convex lens in a case where left circularly polarized light enters, and acts as a concave lens in a case where right circularly polarized light enters.

In addition, in the polarization switching member 14, a relationship between the transmission axis of the linearly polarizing plate 24 and the slow axis of the λ/4 plate 28 is set so that left circularly polarized light is emitted in a case where the phase difference of the liquid crystal cell 26 is 0, and right circularly polarized light is emitted in a case where the phase difference of the liquid crystal cell is λ/2.

As described above, in this example, the linearly polarized light transmitted through the linearly polarizing plate 24 of the polarization switching member 14 is referred to as horizontally polarized light, and the linearly polarized light in a direction orthogonal to the horizontally polarized light is referred to as vertically polarized light. Accordingly, the λ/4 plate 28 emits left circularly polarized light in a case where horizontally polarized light enters, and emits right circularly polarized light in a case where vertically polarized light enters.

First, an action in a case where the phase difference of the liquid crystal cell 26 is 0 will be described.

The unpolarized light emitted from the light source unit 12 enters the polarization switching member 14.

The unpolarized light emitted from the light source unit 12 is first converted into horizontally polarized light that is linearly polarized light by the linearly polarizing plate 24 of the polarization switching member 14. Next, the horizontally polarized light enters the liquid crystal cell 26. In this example, since the phase difference of the liquid crystal cell 26 is 0, the horizontally polarized light is transmitted through the liquid crystal cell 26 as it is, and enters the λ/4 plate 28 as horizontally polarized light. As described above, since the λ/4 plate 28 changes the horizontally polarized light into left circularly polarized light, the horizontally polarized light entering the λ/4 plate 28 is converted into left circularly polarized light, and emitted from the polarization switching member 14.

The left circularly polarized light emitted from the polarization switching member 14 then enters the directivity control member 16 (louver member). Of the left circularly polarized light entering the directivity control member 16, the left circularly polarized light whose traveling direction forms an angle with respect to the optical axis of the liquid crystal lens 18a is shielded by the cylindrical member 16a, and only the left circularly polarized light whose traveling direction is parallel or nearly parallel to the optical axis of the liquid crystal lens 18a passes through the cylindrical member 16a and enters the liquid crystal lens array 18.

As described above, the liquid crystal lens 18a in the liquid crystal lens array 18 acts as a convex lens in a case where left circularly polarized light enters. Accordingly, the left circularly polarized light entering the liquid crystal lens 18a is converted into right circularly polarized light and collected, and as a result, the light is irradiated to a narrow range.

Then, the right circularly polarized light with which the narrow range is irradiated enters the liquid crystal display unit 20 as backlight light. Accordingly, the image display by the liquid crystal display device in this case is an image display with a narrow viewing angle.

Meanwhile, in a case where the phase difference of the liquid crystal cell 26 is λ/2, the unpolarized light emitted from the light source unit 12 also enters the polarization switching member 14.

Similarly, the unpolarized light emitted from the light source unit 12 is converted into horizontally polarized light by the linearly polarizing plate 24 of the polarization switching member 14. Next, the horizontally polarized light enters the liquid crystal cell 26. In this example, since the phase difference of the liquid crystal cell 26 is λ/2, the polarization direction of the horizontally polarized light is rotated by 90°, and thus the horizontally polarized light becomes vertically polarized light and enters the λ/4 plate 28. As described above, since the λ/4 plate 28 changes the vertically polarized light into right circularly polarized light, the vertically polarized light entering the λ/4 plate 28 is converted into right circularly polarized light, and emitted from the polarization switching member 14.

The right circularly polarized light emitted from the polarization switching member 14 similarly enters the directivity control member 16, and only the right circularly polarized light whose traveling direction is parallel or nearly parallel to the optical axis of the liquid crystal lens 18a passes through the cylindrical member 16a and enters the liquid crystal lens array 18.

As described above, the liquid crystal lens 18a in the liquid crystal lens array 18 acts as a concave lens in a case where right circularly polarized light enters. Accordingly, the right circularly polarized light entering the liquid crystal lens 18a is converted into left circularly polarized light and diffused (diverged), and as a result, the light is irradiated to a wide range.

Then, the left circularly polarized light with which the wide range is irradiated enters the liquid crystal display unit 20 as backlight light. Accordingly, the image display by the liquid crystal display device in this case is an image display with a wide viewing angle.

The directivity switching lighting device according to the embodiment of the present invention has been described in detail above, but the present invention is not limited to the above-described examples, and various improvements and modifications may be made within a range not departing from the gist of the present invention.

The directivity switching lighting device according to the embodiment of the present invention is suitably usable as a backlight unit or the like of a liquid crystal display device.

### EXPLANATION OF REFERENCES

10: lighting device
12: light source unit
14: polarization switching member
16: directivity control member
16a: cylindrical member
18: liquid crystal lens array
18a: liquid crystal lens
20: liquid crystal display unit
24: linearly polarizing plate
26: liquid crystal cell
28: λ/4 plate
32: substrate
34: alignment film
36: liquid crystal layer
38: liquid crystal compound
38A: optical axis
80: exposure device
82: laser
84: light source
86, 94: polarization beam splitter
90A, 90B: mirror
92: lens
96: λ/4 plate

What is claimed is:

1. A directivity switching lighting device comprising:
a light source;
a polarization switching member that switches between right circularly polarized light and left circularly polarized light;
a liquid crystal lens array; and
a directivity control member that controls directivity of light emitted from the light source,
wherein the light source, the polarization switching member, and the liquid crystal lens array are disposed in this order, and
the directivity control member is disposed between the light source and the polarization switching member or between the polarization switching member and the liquid crystal lens array.

2. The directivity switching lighting device according to claim 1,
wherein the polarization switching member has a polarizing plate, a liquid crystal cell, and a λ/4 plate in this order from a light source side.

3. The directivity switching lighting device according to claim 1,
wherein the directivity control member has one or more of a louver member, a prism sheet, or a collimating lens array.

4. The directivity switching lighting device according to claim 3,
wherein the louver member is an arrangement of light-shielding cylindrical bodies that are provided corresponding to liquid crystal lenses forming the liquid crystal lens array.

5. The directivity switching lighting device according to claim 1,
wherein the liquid crystal lens forming the liquid crystal lens array is a liquid crystal diffraction lens that includes a liquid crystal layer having a concentric liquid crystal alignment pattern in which an orientation of an optical axis derived from a liquid crystal compound changes while continuously rotating along at least one in-plane direction, in which a liquid crystal compound is immobilized.

6. The directivity switching lighting device according to claim 2,
wherein the directivity control member has one or more of a louver member, a prism sheet, or a collimating lens array.

7. The directivity switching lighting device according to claim 6,
wherein the louver member is an arrangement of light-shielding cylindrical bodies that are provided corresponding to liquid crystal lenses forming the liquid crystal lens array.

8. The directivity switching lighting device according to claim 2,
wherein the liquid crystal lens forming the liquid crystal lens array is a liquid crystal diffraction lens that includes a liquid crystal layer having a concentric liquid crystal alignment pattern in which an orientation of an optical axis derived from a liquid crystal compound changes while continuously rotating along at least one in-plane direction, in which a liquid crystal compound is immobilized.

9. The directivity switching lighting device according to claim 3,
wherein the liquid crystal lens forming the liquid crystal lens array is a liquid crystal diffraction lens that includes a liquid crystal layer having a concentric liquid crystal alignment pattern in which an orientation of an optical axis derived from a liquid crystal compound changes while continuously rotating along at least one in-plane direction, in which a liquid crystal compound is immobilized.

10. The directivity switching lighting device according to claim 4,
wherein the liquid crystal lens forming the liquid crystal lens array is a liquid crystal diffraction lens that includes a liquid crystal layer having a concentric liquid crystal alignment pattern in which an orientation of an optical axis derived from a liquid crystal compound changes while continuously rotating along at least one in-plane direction, in which a liquid crystal compound is immobilized.

11. The directivity switching lighting device according to claim 6,
wherein the liquid crystal lens forming the liquid crystal lens array is a liquid crystal diffraction lens that includes a liquid crystal layer having a concentric liquid crystal alignment pattern in which an orientation of an optical axis derived from a liquid crystal compound changes while continuously rotating along at least one in-plane direction, in which a liquid crystal compound is immobilized.

12. The directivity switching lighting device according to claim 7,
wherein the liquid crystal lens forming the liquid crystal lens array is a liquid crystal diffraction lens that includes a liquid crystal layer having a concentric liquid crystal alignment pattern in which an orientation of an optical axis derived from a liquid crystal compound changes while continuously rotating along at least one in-plane direction, in which a liquid crystal compound is immobilized.
